(19) United States
(12) Patent Application Publication
(10) Pub. No.: US 2014/0283125 A1
(43) Pub. Date: Sep. 18, 2014

(54) FACIAL RECOGNITION-BASED INFORMATION DISCOVERY

(71) Applicant: GROUND SIX SPACEWORKS, (US)

(72) Inventors: Martin Luke Stanley, Newcastle upon Tyne (GB); Michael Keith Peacock, County Durham (GB)

(73) Assignee: GROUND SIX SPACEWORKS, Newcastle upon Tyne (GB)

(21) Appl. No.: 13/840,819

(22) Filed: Mar. 15, 2013

(51) Int. Cl. G06F 21/62

(52) U.S. Cl. CPC G06F 21/62
USPC 726/28; 726/27

(57) ABSTRACT

A system and method thereof for control, by a user, regarding information made publicly available about the user to authorized services and/or applications based on an image of the face of the user. A system and method thereof for obtaining user-related information based on facial recognition.

### BACKGROUND

Federated login and authorization services exist, such as oAuth, which allow two separate systems to communicate and share authorization details and login credentials. This allows a user to permit one system to access user information from another system.

In some instances, subjects make their own personal information available to online services, databases and other users, e.g. by data entry forms, creating web pages or signup to social networking sites. Such personal information is usually comprised of text data and indexed by keywords. Tools such as search engines build and maintain these indexes and allow them to be searched by use of keywords. In some situations, this personal information is directly supplied by the user in order to be made publicly available.

Facial recognition is a process which allows for the automatic identification or verification of a person from an image. Prior approaches have utilized facial recognition for identification primarily to look up pre-existing information in a system or organization-controlled database, e.g., criminal or governmental records looking up information not inputted by the subject.

Recognition may be performed with respect to multiple individuals and the resulting information relates to the personal information of the individuals as such and not to a collectively predefined piece of information.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level block diagram of a system usable in conjunction with one or more embodiments;

FIG. 2 is a block diagram of a controller-based system usable in conjunction with an embodiment;

FIG. 3 is a functional block diagram of functionality of a platform according to an embodiment;

FIG. 4 is a high-level process flow for information lookup according to an embodiment;

FIG. 5 is a functional block diagram of third party application management functionality of the platform according to an embodiment;

FIG. 6 is a high-level process flow for third party application authorization according to an embodiment;

FIG. 7 is a high-level functional block diagram of a use case according to an embodiment;

FIG. 8 is a high-level functional block diagram of another use case according to an embodiment;

FIG. 9 is a high-level functional block diagram of another use case according to an embodiment;

FIG. 10 is a process flow diagram of a method of user lookup according to an embodiment; and

FIG. 11 is a process flow diagram of a method of training according to an embodiment.

### DETAILED DESCRIPTION

The following disclosure provides many different embodiments, or examples, for implementing different features of the invention. Specific examples of components and arrangements are described below to simplify the present disclosure. These are examples and are not intended to be limiting.

Platform

A concept related to at least one of the embodiments of a facial recognition-based information discovery (FRID) platform is providing the ability for the end user (user) to manage their facial identity profile with the platform. The user supplies and manages training images which are used to index an image database against their facial identity.

The user is also able to store, in relation to the index (also referred to as the facial index), predefined and/or arbitrary profile information, including but not limited to:

Contact details;

Personal details;

Authorization details (also referred to as permission settings), and;

Images and documents.

A third party application, i.e., an executable set of instructions separate from the FRID software executed by a processor or controller, requests access to at least a subset of user profile information. In response, the user is prompted to authorize the application and configure which subset of user profile information, if any, the third party application is allowed to access.

The third party application is then able to utilize results from the facial index and profile database which relate to the particular user profile when trying to lookup the facial identity of a user via an image. For example, if “Application A” is authorized to access a particular facial profile, name and email address, if Application A then sends an image to the FRID platform, if the face is found in the image, the platform returns the name and email address to application A, as duly authorized.

The third party application is also able to, subject to the profile authorization details of a particular user, update profile information, for example by providing new training images, accessing training images or updating contact details of a particular profile of the user.

In at least some embodiments, there is the ability to perform an authorization between a third party application or service and a particular user's account on the FRID platform.

In at least some embodiments, the particular user is able to control what pieces of profile information the third party application or other user is able to access or receive.

In at least some embodiments, the particular user makes some or all information public to one, more than one, or all applications/services without prior authorization.

In at least some embodiments, some third party applications only request information about the facial profile, i.e., the third party applications maintain their own collection of personal/private data.

In at least some embodiments, the FRID platform returns, upon authorization, the facial identifier (ID) corresponding to a stored image corresponding to an authenticated user.

In at least some embodiments, upon facial lookup and provided a user authorized a third party application, the FRID platform returns the facial ID (which the third party could use to lookup its own data) and pre-authorized profile information.

In at least some embodiments, a third party application accesses information by querying against a facial index. In at least some embodiments, a facial index refers to what an image is searched against. A facial recognition process returns an identifier (ID) and a record of the IDs is maintained in platform 300 along with the profile information and submitted training images, as described herein. The ID is assigned and fixed for a particular profile. In at least some embodiments, third party application software uses the ID to link between a user profile in the particular third party application software with a user profile in the FRID platform 300.

In at least some embodiments, third party developers are able to build applications for accessing the FRID platform without worrying about managing the users profile information and facial indices.

In at least some embodiments, the user manages authorization details at any time.

In at least some embodiments, a generic linking process to connect a user profile to a third party application accessing the user profile on the FRID is used, e.g., oAuth.

In at least some embodiments, a third party registers with the FRID platform and obtains credentials. In an example usage of the FRID platform: a database of users, URLs and a facial index is created. The FRID platform handles the user-controllable database of profile information (URLs, etc) and maintains an index in conjunction with a facial recognition service. Faceifi (the product, not this platform) instead of dealing with users training the system and providing the system with profile details, would be authorized to see a users platform profile. When a third party application attempts to lookup the URL of a person in a photo, the FRID platform performs the lookup to determine who is in the photo, and provided the requestor has authorization to access the profile data, returns the requested profile data.

In effect, the FRID platform is the central place for a user to manage the technology-enabled identity associated with their face.

In at least some embodiments, the pieces of user profile information returned to the requesting user is transmitted in a combined manner with the user image or recognized facial portion of the image, e.g., user profile information overlaid on a portion of the image.

FIG. 1 is a high-level block diagram of a system 100 comprising a facial recognition-based information discovery (FRID) platform 102 usable in conjunction with one or more embodiments. Platform 102 is a controller-based system for executing one or more instructions to interact with an identified user 104 via a user-controlled computing device 106 and to interact with a searching user 108 via another user-controlled computing device 110.

In at least one embodiment, the identified user 104 using the user-controlled computing device 106 interacts with platform 102 in order to log on and transmit an image of the identified user for storage by the platform. Identified user 104 also interacts with platform 102 in order to supply one or more pieces of information for a profile of the user to be stored by the platform. At a later time, the searching user 108 acquires an image of a target user 112, e.g. via user-controlled computing device 110 (for example, a cellular telephone having sufficient functionality), and transmits the acquired image to platform 102 and requests user profile information related to the target user. After receipt of the image and request from the searching user 108, platform 102 proceeds to perform a facial recognition process on the acquired image in order to match a face in the image with other images available to the platform. If a match is found, platform 102 transmits a reply to the searching user 108 wherein the reply comprises one or more pieces of user profile information related to the matching image. If the facial recognition performed on the image transmitted by searching user 108 matches with the image transmitted by the identified user 104, platform 102 transmits one or more of the supplied pieces of information from the identified user to the searching user.

In at least some embodiments, the identified user 104 supplies one or more images for training the facial recognition system, either used by the platform 102 or included in the platform 102, to improve recognition of the identified user. In at least some embodiments, the identified user 104 supplies one or more controls to authorize or deauthorize particular entities, e.g., other users such as searching user 108 or organizations, access to profile information about the identified user. In at least some embodiments, the authorized/deauthorized organizations comprise application software requesting access to profile information. In at least some embodiments, the identified user 104 supplies credentials, such as username and password, in order to log on to the platform 102. In at least some embodiments, the searching user 108 supplies credentials to platform 102 in order to transmit the acquired image to the platform.

In at least some embodiments, the identified user 104 interacts with platform 102 to create a group comprising more than one user. The identified user 104 supplies information including images corresponding to one or more members of the group or images of the group. In at least some embodiments, the identified user 104 interacts with platform 102 to cause the platform to transmit an invitation message to one or more members of the group indicating existence of the group. The members of the group are able to interact with the platform 102 in order to supply pieces of information about themselves and/or the group and to be able to specify access permissions with respect to one or more of the supplied pieces of information.

FIG. 2 is a high-level block diagram of a controller-based system 200 usable for implementing a FRID platform, such as FRID platform 102, in conjunction with one or more embodiments. One or more embodiments of the present invention is usable with personal computers, mini-mainframes and the like.

Controller-based system 200 includes a bus 202 or other communication mechanism for communicating information, and a controller 204 coupled with the bus 202 for processing information. In at least some embodiments, controller 204 is a processor, microprocessor, application specific integrated circuit or the like for executing instructions.

Controller-based system 200 also includes a memory 206, such as a random access memory (RAM) or other dynamic storage device, coupled to the bus 202 for storing transaction and interaction data, and instructions to be executed by controller 204. Memory 206 also may be used for storing temporary variables or other intermediate information during execution of instructions to be executed by controller 204. In at least some embodiments, controller-based system 200 further includes a read only memory (ROM) or other static storage device coupled to the bus 202 for storing static information and instructions for the controller 204. In at least some embodiments, a storage device, such as a magnetic disk or optical disk, is provided and coupled to the bus 202 for storing images, profile information, credentials, and/or instructions and the like.

In at least some embodiments, controller-based system 200 may be coupled via the bus 202 to a display, such as a cathode ray tube (CRT) or a flat panel display. An input/output device 208 such as a display and/or a keyboard may, in some embodiments, be coupled to bus 202. In at least some embodiments, a keyboard, including alphanumeric and function keys, is coupled to the bus 202 for communicating information and command selections to the controller 204. Another type of user input device is cursor control, such as a mouse, a trackball, or cursor direction keys for communicating direction information and command selections to controller 204 and for controlling cursor movement on the display. This input device typically has two degrees of freedom in two axes, a first axis (e.g., x) and a second axis (e.g., y) allowing the device to specify positions in a plane.

One or more embodiments is related to the use of controller-based system 200, such as the illustrated system of FIG. 2, to enable the use of facial recognition results for information discovery. According to one embodiment of the invention, the facial recognition is performed and profile results provided by controller-based system 200 in response to controller 204 executing sequences of instructions contained in memory 206 in response to input received via input device, cursor control, or other communication interface. Such instructions may be read into memory 206 from another computer-readable medium, such as a storage device.

In at least one embodiment, memory 206 comprises a set of executable instructions comprising a FRID executable 212 for performing one or more methods according to an embodiment.

However, the computer-readable medium is not limited to devices such as a storage device. For example, the computer-readable medium may include a floppy disk, a flexible disk, hard disk, magnetic tape, or any other magnetic medium, a compact disc-read only memory (CD-ROM), any other optical medium, punch cards, paper tape, any other physical medium with patterns of holes, a random access memory (RAM), a programmable read only memory (PROM), an electrically programmable ROM (EPROM), a FLASH-EPROM, any other memory chip or cartridge. Execution of the sequences of instructions contained in the memory 206 causes the controller 204 to perform the process steps described below. In alternative embodiments, hard-wired circuitry may be used in place of or in combination with computer software instructions to implement the invention. Thus, embodiments of the invention are not limited to any specific combination of hardware circuitry and software.

Controller-based system 200 also includes a communication interface (I/F) 210 coupled to the bus 202. Communication interface 210 provides two-way data communication. For example, communication interface 210 may be an integrated services digital network (ISDN) card, a digital subscriber line (DSL) card, or a modem to provide a data communication connection to a corresponding type of telephone line. As another example, communication interface 210 may be a local area network (LAN) card to provide a data communication connection to a compatible LAN. Wireless links may also be implemented. In any such implementation, communication interface 210 sends and receives electrical, electromagnetic or optical signals which carry digital data streams representing various types of information. Of particular note, the communications through interface 210 may permit transmission or receipt of images and/or profile information. For example, two or more controller-based systems 200 may be networked together in a conventional manner with each using the communication interface 210.

Communication interface 210 also typically provides data communication through one or more networks to other data devices. For example, communication interface 210 may provide a connection through a local network to a computer or to data equipment operated by an Internet Service Provider (ISP). The ISP in turn provides data communication services through the world wide packet data communication network now commonly referred to as the “Internet”. The local network and Internet both use electrical, electromagnetic or optical signals which carry digital data streams.

Controller-based system 200 can send messages and receive data, including program code, through the network(s) via communication interface 718.

In at least some embodiments, user-controllable devices 106, 110 may comprise similar components as controller-based system 200.

FIG. 3 is a functional block diagram of at least a subset of platform functionality according to an embodiment of a platform 300 such as FRID platform 102.

The diagram depicts at least a subset of the functions that an end user performs using the platform. In at least some embodiments, the user interacts with platform functionality of the platform 300 by accessing the platform via a web browser, a third party application, or a platform-provided executable application.

The user interacting with the platform 300 is able to manage their facial identity by uploading training image functionality 302 and remove training image functionality 304. Through use of this functionality, the user is able to transmit or transfer one or more images to the platform and remove one or more images from the platform. After the user uploads and/or removes one or more training images, the facial index corresponding to the images is retrained.

In at least some embodiments, the retraining of the facial indexes is performed automatically. In at least some embodiments, the automatic retraining of facial indexes is performed responsive to the expiration of a timer. In at least some embodiments, the retraining is performed responsive to a predetermined number of images being uploaded and/or removed. In at least some embodiments, the retraining of the facial indexes is performed as part of a manual process responsive to input from the user.

The user interacting with platform 300 is also able to create and manage their profile using create profile functionality 306 and/or update profile functionality 308. In this manner, the user is able to provide profile information combined of pre-defined options (e.g. email address, name) and user-defined attributes. The user is able to provide values for both pre-defined attributes and/or user-defined attributes, e.g., height, age, hobbies, and the like.

The user interacting with platform 300 is also able to authorize or deauthorize a third party application to access the facial identity of the user using authorize third party application functionality 310 or deauthorized third party application functionality 312.

The user interacting with platform 300 is also able to manage which attributes are accessible by an authorized third party application using manage privacy settings functionality 314. Using manage privacy settings functionality 314, the user is able to open their profile to one, some, or all application access. In at least some embodiments, using functionality 314 the user is able to open their profile to all application access. Using manage privacy settings functionality 314, the user is also able to close their profile to only be available to explicitly authorized applications.

The user interacting with platform 300 is also able to cause the platform 300 to train the facial recognition system using train facial recognition system functionality 316. In at least some embodiments, platform 300 includes a set of executable instructions for performing facial recognition. In at least some other embodiments, platform 300 accesses a set of executable instructions for performing facial recognition stored on another controller-based system. In at least some other embodiments, platform 300 communicates with another controller-based system storing a set of executable instructions for performing facial recognition and requests the other controller-based system to perform facial recognition and return the results to the platform.

In at least some embodiments, the training of the facial recognition system functionality 316 is performed automatically or manually. In at least some embodiments, the automatic performance of functionality 316 is caused to be performed in response to upload or removal of one or more training images from the platform 300. In at least some embodiments, the manual performance of functionality 316 is performed in response to receipt of an input from the user.

The user interacting with platform 300 is also able to request that the platform lookup an image for a facial recognition match using image lookup functionality 318. Using image lookup functionality 318, the user is able to provide an image to the platform and request that the platform identify at least a portion of the image corresponding to at least a portion of a person's face and perform a facial recognition process on the facial image. The result of the facial recognition process is used to search a database comprising facial identifiers (IDs) to locate a profile of the user corresponding to the matched facial image. The platform 300 then performs additional processing in order to determine whether and/or how many pieces of information from the corresponding located user profile is authorized to be sent in reply to the user.

In at least some embodiments, the interaction with platform 300 is performed by a third party application service in place of a user. In at least some embodiments, all interactions with platform 300 requesting access to at least the image lookup functionality 318 require authorization and/or authentication, e.g., by use of credentials, of the user in order to perform image lookup functionality. In at least some embodiments, more than one image at a time may be supplied to image lookup functionality 318. In at least some embodiments, if the image supplied to image lookup functionality 318 comprises more than one face, than facial recognition is performed on each face in the image. If there is more than one face in the image, the platform 300 processes the image as described herein to determine whether the image comprises a group of users corresponding to a group profile. If the image comprises a group of users corresponding to a group profile, the group profile is looked up and, depending on authorization settings, the permitted information returned in reply to the requester. In at least some embodiments, the authorization and/or authentication processes are performed prior to returning information in reply to the requester.

In at least some further embodiments, if there is a match of an image used to request a lookup and the image used is not already in the database of images of platform 300, the image used is added to the database of images.

FIG. 4 is a high-level process flow for information lookup according to an embodiment.

1. A third party application connects to the platform and authenticates themselves to the platform. In at least some embodiments, the authentication is performed either up-front before issuing requests, or interactions with the platform are signed using credentials proving the identity of the application issuing the requests/commands against the platform.

2. An image is supplied to the platform from a third party application. In at least some embodiments, the image is transmitted to the platform using one or more file transfer protocols. In at least some embodiments, the image is transmitted to the platform using one or more of electronic mail, short message service, or the like. In at least some embodiments, encryption protocols are used to encrypt the transmission between the third party application and the platform.

3. The image is processed to identify the existence of any recognizable faces in the image.

4. If faces are identified as existing in the image, the image is sent to a facial recognition engine which provides a profile index for the matching profiles. In at least some embodiments, the platform transmits the image to a third party facial recognition service. In at least some embodiments, the platform performs facial recognition by executing a set of executable instructions comprising facial recognition functionality.

5. Profile information from the platform database is then looked up using the profile index. In at least some embodiments, the profile information includes:

profile data; and

authorization data (for example, which third party applications the user has authorized to access their information, and which information is available to the applications).

6. Profile information is filtered through a proxy based of the users authorization. That is, if third party Application A submits an image containing User B, the platform will only include User B in the results if User B is both: within the FRID platform and has either: authorized Application A to access a subset of the User B profile or granted all applications access to a subset of the User B profile.

7. The profile data is then filtered again based on the subset of data which the user authorized be disclosed to the requesting application.

8. A response is prepared by the platform after receipt of the profile data.

9. The response is sent to the requesting application.

FIG. 5 is a functional block diagram of functionality according to third party application management of the platform according to an embodiment.

FIG. 5 depicts actions and functions that a third party application creator is able to perform or make accessible to a user (depicted as client in the Figure) of the third party application:
A user can create an account to manage their applications;
A user can create an application;
A user can remove an application; and
A user can update the default requirements for their applications. This defines which attributes the end-user is asked to authorize when they link a third party app to the platform 300.

FIG. 6 is a high-level process flow for third party application authorization according to an embodiment. FIG. 6 depicts at least a portion of the process involved for a user to authorize a third party application to utilize the user profile on the platform. In at least some embodiments, the oAuth system is usable. oAuth is an open standard for authentication and information is available via the Internet Engineering Task Force RFCs 5849, 6749 and related RFCs. A basic process flow of FIG. 6 includes the following:
User of Application A indicates that they wish to link their Platform profile to the application as indicated by a platform link request received from a third party application.
User A is taken to a Platform authorization screen. This screen is generated based off a handshake between the Platform and the third party application.
The user then has the option of either logging in to their Platform account or creating a new Platform account, if they are not already logged in.
The authorization screen lists requested permissions that Application A would like to use when communicating with the user profile.
User selects which permissions to allow (e.g. See default image, see name, see email address) Application A to use.
User preferences are saved in the Platform.
Response returned to Application A including permissions given, the users Platform ID (so the application can store a link between their own database and the Platform database).

Product

A concept of an embodiment of a FRID product, i.e., a set of executable instructions which, when executed, cause a processor to perform functionality, is to allow a user to search for information about someone, that they have opted to make public, using their face. The user is able to control the information found associated with their face. This also applies to groups of people in a photograph or image.

FIG. 7 is a high-level functional block diagram of a use case according to an embodiment related to an embodiment of lookup functionality, e.g., lookup functionality 318 (FIG. 3).

The user through the use of a third party application, e.g., an application programming interface (API) client, provides an image to lookup. The FRID platform 300 looks up profiles based off the image and returns results to the user. The user then views the results via the API client.

The user interacts with the platform 300 via an API client such as a mobile device, web browser or application.

FIG. 8 is a high-level functional block diagram of another use case according to an embodiment.

The user by using the API client provides an image to platform 300 to train the platform. The image is sent to a face detection service, to ensure the image contains a face. If the result is that the image contains a face, the face is associated with a unique ID related to the corresponding user profile. The platform 300 is then trained on the face, as the user's facial identity with the platform has changed.

The user also is able to provide profile information to associate with the unique ID corresponding to the user profile.

The user also is able to remove an image from the corresponding user profile. The platform 300 is then retrained in accordance with the removal of the image. In at least some embodiments, the retraining of the platform 300 is performed either manually or automatically as described herein.

FIG. 9 is a high-level functional block diagram of a use case according to an embodiment.

In accordance with at least one embodiment, the user invites another user to join a group profile. A group profile allows an image, e.g., a photograph, containing multiple people (who may have a corresponding user profile on platform 300) to be recognized as being that specific group of people as opposed to any of them individually. In at least some embodiments, only people having a corresponding user profile are able to be associated with a group profile.

A user is able to create a group which will contain multiple users, and a number of facial profiles. A user is able to add trained faces to a group, so that the members of the group are able to recognize their faces. A user is also able to remove trained faces from a group, so the group does not recognize their faces.

FIG. 10 is a process flow diagram of a method of user and/or group lookup according to an embodiment.

The process flow of FIG. 10 depicts at least a portion of the process for looking up a user based on an image of the face of the user.

1. An image is provided via a user, e.g., using a third party application.

2. The image is sent to a facial recognition service.

3. If at least one face is found a further determination is performed as follows:
If only one face is found, a lookup is performed to determine the user profile corresponding to the found face.
If more than one face is found, a lookup is performed to determine the group profile corresponding to the profile of the user whose face matches one returned from the facial recognition service.

In at least some embodiments, if more than one face is found, a lookup is performed to determine which group profile comprises each of the matching user faces in the image.

4. The response is prepared including the profile information and sent back to the user.

FIG. 11 is a process flow diagram of a method of training the FRID platform regarding an image according to an embodiment.

In at least some embodiments, the execution of the set of instructions corresponding to the method of training causes the platform to be trained on a user's face, and enables the user to set up the corresponding user profile on the platform.

Training

1. A user provides an image to the platform.

2. The provided image is sent to the face detection service.

3. If a face was found in the system, the process flow continues.

4. The facial recognition service is trained to associate the face from the image with a unique identifier which references the appropriate user profile.

Profile
1. A user supplies profile information such as links, contact details and biographical information.

Combined

Provided the user has supplied at least the minimum predetermined number of training images, and the user has provided profile information, then the corresponding user profile is marked as usable, and is able to be looked up using the FRID platform.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method of obtaining user-related information based on facial recognition, the method comprising:
transmitting a request for a user profile, the request comprising at least one image; and
receiving at least one profile of a user whose image matches the at least one image in the transmitted request in excess of a predetermined degree of confidence.

2. The method of claim 1, wherein the at least one profile comprises a uniform resource locator.

3. The method of claim 1, wherein the at least one profile comprises at least one of contact information or biographical information.

4. The method of claim 1, wherein the at least one profile comprises at least one of predefined attribute information or user-defined attribute information.

5. The method of claim 1, wherein transmitting a request further comprises transmitting authentication information.

6. The method of claim 1, wherein the at least one profile comprises only information authorized for release by the user corresponding to the profile.

7. The method of claim 1, further comprising:
using information received in the at least one profile to contact the user.

8. The method of claim 1, wherein the transmitted image comprises an image having a face of more than one person therein.

9. The method of claim 8, wherein the receiving at least one profile comprises receiving a group profile of a group of more than one person.

10. The method of claim 9, further comprising:
displaying on a display the group profile received.

11. A method of generating user-related information based on facial recognition, the method comprising:
receiving a request for a profile, the request comprising at least one image; and
transmitting at least one profile of a user whose image matches the at least one image in the transmitted request in excess of a predetermined degree of confidence.

12. The method of claim 10, wherein the profile comprises one or more permission settings indicating permission to transmit at least a portion of the at least one profile, and wherein transmitting at least one profile is performed to transmit at least a portion of the at least one profile if a permission setting indicates permission to transmit the at least a portion of the at least one profile.

13. The method of claim 10, further comprising:
receiving one or more permission settings indicating permission to transmit one or more portions of the at least one profile; and
storing the received one or more permission settings in relation to the at least one profile.

14. A method of generating group-related information based on facial recognition, the method comprising:
receiving a profile request, the request comprising at least one image; and
transmitting at least one profile of a group having at least one image matching the transmitted request image.

15. The method of claim 14, further comprising:
receiving one or more images related to the group profile; and
storing the images in relation to the group profile.

16. The method of claim 15, further comprising:
receiving one or more pieces of information related to the group profile; and
storing the received one or more pieces of information in relation to the group profile.

16. A memory or a computer-readable medium storing instructions which, when executed by a processor, cause the processor to perform the method of claim 1.
